(19) United States
(12) Patent Application Publication
(10) Pub. No.: US 2008/0178211 A1
(43) Pub. Date: Jul. 24, 2008

(54) SYSTEM AND METHOD FOR OVERLAYING AN ADVERTISEMENT UPON A VIDEO

(76) Inventors: Charles G. Lillo, Davie, FL (US); Justin Goudreau, Fort Lauderdale, FL (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/625,008

(22) Filed: Jan. 19, 2007

(51) Int. Cl. H04N 7/10

(52) U.S. Cl. 725/32

(57) ABSTRACT

A system and method for displaying an advertisement in conjunction with a display of a video on a computer monitor. The system includes at least one server and a client computer that are in communication via a network. The client computer has a monitor. The server is configured to receive a request for a download of a video from the client computer and, in response, to download the video and the one or more advertisements to the client computer. When a user causes the client computer to display the received video, the one or more advertisements is displayed as an overlay with respect to a portion of the video being displayed and at a predetermined time with respect to the beginning of the display of the video. The server may be further configured to track impressions and/or click-throughs relating to the display of the one or more advertisements.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND

1. Field of the Invention

The present invention relates to advertising systems. More particularly, the present invention relates to a system and method for overlaying an advertisement upon a video.

2. Related Art

Since the advent of the Internet, advertisers have placed advertisements on various web sites and in association with specific portions of web sites. A more recent development has been the ability to download streaming video from a network server for viewing on one's personal computer monitor. Conventionally, when a user activates such a video, the video may be preceded by a video advertisement. However, advertisers have a need for placing advertisements during the playing of the video, in addition to placing ads before and/or after a video.

### SUMMARY OF THE INVENTION

In one aspect, the invention provides a system for displaying one or more advertisements. The system includes a server computer and a client computer. The client computer has a monitor. The client computer is in communication with the server computer via a network. The server computer is configured to receive a request for a download of a video from the client computer and, in response to the received request, to download the video and the one or more advertisements to the client computer. The client computer is configured to receive the downloaded video and the downloaded one or more advertisements from the server computer. When a user submits a request for displaying the received video, the client computer is further configured to display the received video on the monitor, and to display the one or more advertisements as an overlay with respect to a portion of the video being displayed.

The client computer may be further configured to begin displaying the one or more advertisements after a predetermined interval from a time at which the display of the received video begins. The video may include a start marker corresponding to the predetermined interval. The client computer may be further configured to begin displaying the one or more advertisements in response to an occurrence of the start marker. The server computer may be further configured to track impressions relating to the display of the one or more advertisements. The server computer may be further configured to track click-throughs relating to the display of the one or more advertisements.

In some embodiments, at least one of the one or more advertisements is displayed as an overlay with respect to at least 1% of the video being displayed and at most about 75% of the video being displayed. In other embodiments, at least one of the one or more advertisements is displayed at a location that is selected from the group consisting of a left-hand side of the video, a right-hand side of the video, a bottom side of the video, a top side of the video, and a central location with respect to the video. In still other embodiments, when at least one of the one or more advertisements is displayed, the client computer is configured to enable the user to cause the video to be paused. In yet other embodiments, when at least one of the one or more advertisements is displayed, the server computer is configured to automatically pause the video.

In another aspect, the invention provides a system for displaying one or more advertisements. The system includes a video server computer, one or more advertisement server computers, and a client computer. The client computer has a monitor. The video server computer, the one or more advertisement server computers, and the client computer are in mutual communication via a network. The video server computer is configured to receive a request for a download of a video from the client computer and, in response to the received request, to download the video to the client computer. When the video is downloaded to the client computer, the one or more advertisement server computers are configured to download the one or more advertisements to the client computer. The client computer is configured to receive the downloaded video from the video server computer and to receive the downloaded one or more advertisements from the one or more advertisement server computers. When a user submits a request for displaying the received video, the client computer is further configured to display the received video on the monitor, and to display the one or more advertisements as an overlay with respect to a portion of the video being displayed.

The client computer may be further configured to begin displaying the one or more advertisements after a predetermined interval from a time at which the display of the received video begins. The video may include a start marker corresponding to the predetermined interval. The client computer may be further configured to begin displaying the one or more advertisements in response to an occurrence of the start marker. The one or more advertisement server computers may be further configured to track impressions relating to the display of the one or more advertisements. The one or more advertisement server computers may be further configured to track click-throughs relating to the display of the one or more advertisements.

In some embodiments, at least one of the one or more advertisements is displayed as an overlay with respect to at least 1% of the video being displayed and at most about 75% of the video being displayed. In other embodiments, at least one of the one or more advertisements is displayed at a location that is selected from the group consisting of a left-hand side of the video, a right-hand side of the video, a bottom side of the video, a top side of the video, and a central location with respect to the video. In still other embodiments, when at least one of the one or more advertisements is displayed, the client computer is configured to enable the user to cause the video to be paused. In yet other embodiments, when at least one of the one or more advertisements is displayed, the server computer is configured to automatically pause the video.

In yet another aspect, the invention provides a method for displaying one or more advertisements on a monitor of a client computer that is in communication with at least one server computer over a network. The method includes the steps of: a) receiving a request for a download of a video from the client computer; b) in response to the request, causing the video to be displayed on the monitor of the client computer; and c) causing the one or more advertisements to be displayed on the monitor of the client computer as an overlay with respect to a portion of the video being displayed. A beginning of causing the one or more advertisements to be displayed may occur after a predetermined interval from a time at which a beginning of causing the video to be displayed occurs. The video may include a start marker corresponding to the predetermined interval. The beginning of causing the one or more advertisements to be displayed may occur in response to an occurrence of the start marker. The method may further include the step of tracking impressions relating to the display of the one or more advertisements. The method may further include the step of tracking click-throughs relating to the display of the one or more advertisements. The client computer may be in communication with at least a video server computer and one or more advertisement server computers. The video server computer may be configured to execute steps a) and b). The one or more advertisement server computers may be configured to execute step c). In some embodiments, at least one of the one or more advertisements is displayed as an overlay with respect to at least 1% of the video being displayed and at most about 75% of the video being displayed. In other embodiments, at least one of the one or more advertisements is displayed at a location that is selected from the group consisting of a left-hand side of the video, a right-hand side of the video, a bottom side of the video, a top side of the video, and a central location with respect to the video. In still another embodiment, when at least one of the one or more advertisements is displayed, the client computer is configured to enable the user to cause the video to be paused. In yet another embodiment, when at least one of the one or more advertisements is displayed, the server computer is configured to automatically pause the video.

In still another aspect of the invention, a computer-readable medium containing a computer program for displaying one or more advertisements is provided. The computer program performs the steps of: a) receiving a request for a download of a video from a user; and b) downloading the video and the one or more advertisements. When the user causes the video to be displayed, the one or more advertisements are displayed as an overlay with respect to a portion of the video being displayed. A beginning of displaying the one or more advertisements may occur after a predetermined interval from a time at which the user causes the video to be displayed. The video may include a start marker corresponding to the predetermined interval. The beginning of displaying the one or more advertisements may occur in response to an occurrence of the start marker. The computer program may further perform the step of tracking impressions relating to the display of the one or more advertisements. The computer program may further perform the step of tracking click-throughs relating to the display of the one or more advertisements. In one embodiment, at least one of the one or more advertisements is displayed as an overlay with respect to at least 1% of the video being displayed and at most about 75% of the video being displayed. In another embodiment, at least one of the one or more advertisements is displayed at a location that is selected from the group consisting of a left-hand side of the video, a right-hand side of the video, a bottom side of the video, a top side of the video, and a central location with respect to the video. In still another embodiment, the computer program further performs the step of enabling the user to pause the video when at least one of the one or more advertisements is being displayed. In yet another embodiment, the computer program further performs the step of automatically pausing the video when at least one of the one or more advertisements is displayed

### BRIEF DESCRIPTION OF THE DRAWINGS

Objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system 100 for overlaying an advertisement upon a video, in accordance with an exemplary embodiment of the present invention.

FIG. 2 is a flowchart illustrating a method for overlaying an advertisement upon a video, in accordance with an exemplary embodiment of the present invention.

### DETAILED DESCRIPTION OF THE PREFERRED EMBODIMENTS

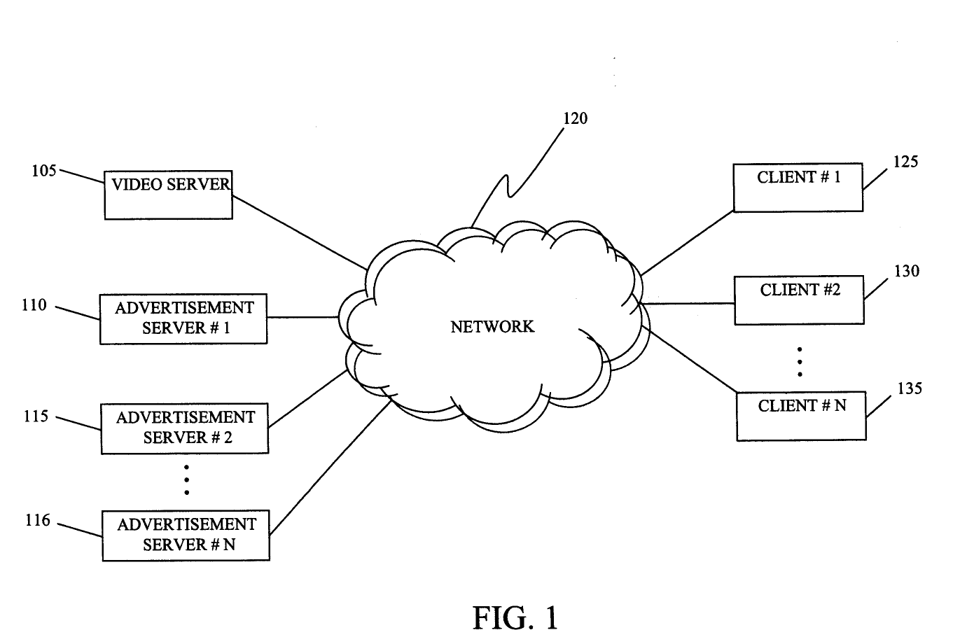

Exemplary embodiments of the present invention are directed to a system and method for displaying an advertisement as an overlay upon a video. FIG. 1 is a block diagram illustrating a system 100 for displaying one or more advertisements as an overlay upon a video, in accordance with an exemplary embodiment of the present invention. In one embodiment, the one or more advertisements come from one advertiser. In another embodiment, the one or more advertisements come from more than one advertiser. The system 100 includes video server 105, advertisement server 110, and client computers 125, 130, 135. The servers 105, 110 and the client computers 125, 130, 135 are in communication via a network 120, such as a local area network (LAN), a wide area network (WAN), an Intranet, or the Internet. Each client computer 125, 130, 135 is configured to submit a request for a download of a video to the video server 105 via the network 120. When the video server 105 receives a request, the video server 105 downloads the requested video to the client computer 125, 130, or 135 that submitted the request. Additionally, the advertisement servers 110, 115 and 116 download one or more advertisements to the client computer 125, 130, or 135 that submitted the request. Although this suggests that the one or more advertisements can come from two different advertisement servers, this is not required. In some embodiments, the one or more advertisements can come from the same server.

In an optional embodiment, the advertisement servers 110, 115 and 116 can be third-party servers (i.e., servers that do not belong to the entity that owns the video server 105). In some embodiments, third-party advertisement servers are the preferred method for the delivery of advertisement to the client computer 125, 130, or 135 because the third-party can provide a centralized access to tools and reports (e.g., how many times any one advertisement is viewed per day) to the entity that uses the system and method of the displaying the one or more advertisements as an overlay upon a video.

According to an exemplary embodiment, each client computer 125, 130, 135 has the ability to display graphical and/or textual information to a user. For example, each client computer 125, 130, 135 can be configured to display a webpage relating to one or more remote sites accessible via the network 120, as well as to allow the user to display the video on his monitor. Additionally, the client computer 125, 130, 135 can comprise a portal or interface through which the user provides or otherwise enters the request for a downloaded video and other associated information for use by the system 100. In other words, the client computer 125, 130, 135 can be configured to display a graphical user interface to the user for interacting with the system 100. The client computer 125, 130, 135 can include any suitable type of user interface capable of displaying graphical and/or textual information to a user and receiving graphical and/or textual information from the user. For example, the client computer 125, 130, 135 can be configured to display a graphical user interface through a suitable Web browser (e.g., Internet Explorer, Netscape, Firefox, Safari, Opera, or any other suitable Web browser) on any appropriate type of display, such as a computer monitor or other display device (e.g., a personal digital assistant (PDA), a suitable cellular phone, or a like portable display).

Each of modules of the system 100, including the video server 105, the advertisement server 110, the network 120, and the client computers 125, 130, 135, can be comprised of any suitable type of electrical or electronic component or device that is capable of performing the functions associated with the respective element. According to such an exemplary embodiment, each component or device can be in communication with another component or device using any appropriate type of electrical connection that is capable of carrying (e.g., electrical) information. Alternatively, each of the modules of the system 100 can be comprised of any combination of hardware, firmware and software that is capable of performing the functions associated with the respective module.

Alternatively, the system 100 can be comprised of one or more microprocessors and associated memory(ies) that store the steps of a computer program to perform the functions of any or all of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of any or all of the modules of the system 100. For example, the actual source code or object code of the computer program can be stored in the memory.

Alternative architectures or structures can be used to implement the various functions of the system 100 as described herein. For example, functions from two or more modules can be implemented in a single module, or functions from one module can be distributed among several different modules. In particular, the functions of the video server 105 and the advertisement server 110 may be carried out by a single server module.

Each of the one or more advertisements can include any type of message provided by the advertiser. In some embodiments, the one or more advertisements comprise streaming video. In other embodiments, the one or more advertisements comprise a static message and/or a static image. In still other embodiments, the one or more advertisements comprise a message or an image that scrolls across the video. In yet other embodiments, the one or more advertisements can comprise one or more of a streaming video, a static message and/or a static image or a message and/or image that scrolls across the video. When more than one advertisement is displayed sequentially, each advertisement can comprise one or more of a streaming video, a static message and/or a static image or a message and/or image that scrolls across the video. Thus, as a non-limiting example, if two advertisements are displayed sequentially, the first advertisement can comprise a static message and the second advertisement can comprise streaming video, or vice versa. Likewise, when more than one advertisement is displayed at the same time, each advertisement can comprise one or more of a streaming video, a static message and/or a static image or a message and/or image that scrolls across the video. Thus, as a non-limiting example, if two advertisements are displayed at the same time, the first advertisement can comprise a static image and the second advertisement can comprise streaming video, or vice versa.

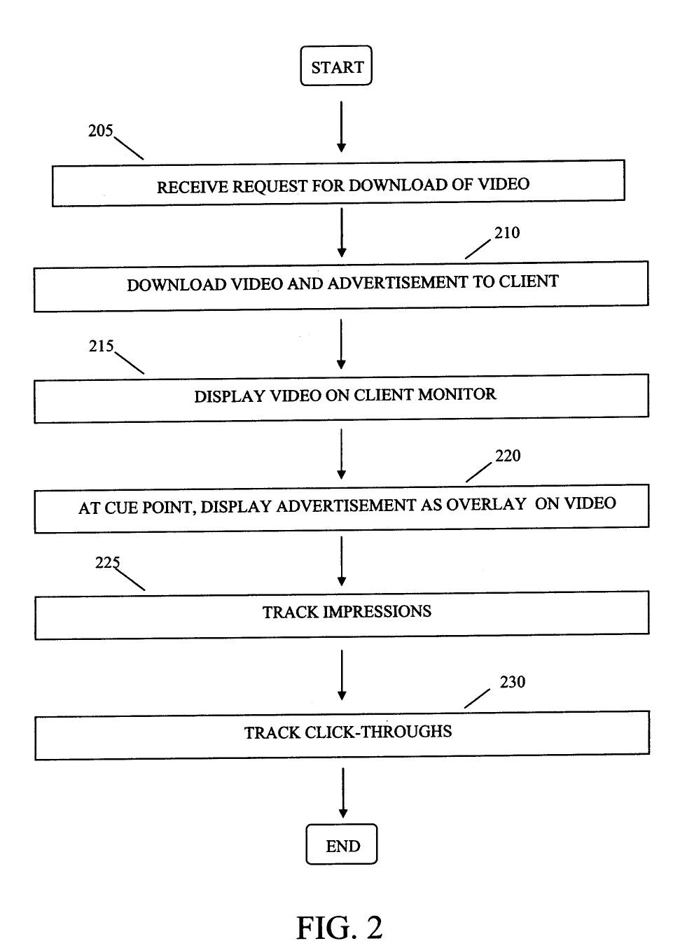

FIG. 2 is a flowchart illustrating steps for displaying an advertisement as an overlay upon a video, in accordance with an exemplary embodiment of the present invention. In step 205, a request for a download of a video is received. Typically, in the preferred embodiment, the request is sent from the client computer 125, 130, 135 to the video server 105 via the network 105. In the next step 210, the requested video and an accompanying advertisement are downloaded to the client. Then, at step 215, the video is displayed on the client monitor. For example, once the video has been downloaded to the client computer, a user may click on the video to cause the video to be displayed on the monitor.

For the next step 220, at a cue point, the downloaded one or more advertisements are displayed as an overlay on the video. In some embodiments, when more than one advertisement is displayed, the advertisements are displayed at the same time. In other embodiments, when more than one advertisement is displayed, the advertisements are displayed sequentially. When one or more advertisements are displayed, the advertisements can be displayed as an overlay on any location on the video. Thus, for example, when only one advertisement is displayed, it can be displayed as an overlay on the left-hand side of the video, the right-hand side of the video, the bottom side of the video, the top side of the video or any location in between the right-hand side of the video or any location in between the top and the bottom of the video. When more than one advertisement is displayed sequentially, each advertisement can be displayed in sequence as an overlay on the same location or on a different location on the video. Thus, as a non-limiting example, if two advertisements are displayed sequentially, the first advertisement can be displayed as an overlay on the bottom of the video and the second advertisement can be displayed on the top of the video, or vice versa. When more than one advertisement is displayed at the same time, each advertisement can be displayed as an overlay on a different location on the video. Thus, as a non-limiting example, if two advertisements are displayed at the same time, the first advertisement can be displayed as an overlay on the bottom of the video and the second advertisement can be displayed on the top of the video, or vice versa.

When displayed as an overlay on the video, the amount of “screen real estate” that the advertisement can occupy can be from about 0.01% to about 100%, e.g., from about 1% to about 75%, from about 5% to about 50%, or from about 10% to about 60% of the screen real estate. In some embodiments, the screen real estate that the advertisement occupies can be about 20%, about 30%, about 40%, about 50%, about 60%, or about 75%. In other embodiments, at least one of the one or more advertisements is displayed as an overlay with respect to at least 1% of the video being displayed and at most about 75% of the video being displayed. As used herein, the term “screen real estate” refers to the portion of the video being displayed, expressed in percent of the total area of the video being displayed, that the advertisement occupies. In other words, screen real estate does not necessarily refer to the percent amount of space that the advertisement occupies on the monitor, unless the video is occupying the entire monitor. Thus, for example, if the video that the advertisement overlays occupies 50% of the monitor and the advertisement occupies 10% of the screen real estate, the advertisement would occupy 10% of the 50% of the monitor because it would overlay 10% of the video.

The downloaded video file typically contains one or more markers, such as a start marker, to indicate that the advertisement is to be displayed. The start marker, or cue point, may be placed within the video file at any desired point such that the display of the advertisement will begin at a specific known time. Thus, in this manner, the advertisement is displayed to the user. In a preferred embodiment, the start marker is placed within the video file near the beginning of the video file. In another preferred embodiment, the video and the one or more advertisements are displayed concurrently. In optional embodiments, the user can cause the video to be paused and the one or more advertisements to be displayed. In other optional embodiments, the video is paused automatically (i.e., without user intervention) while the one or more advertisements are displayed.

At step 225, impressions of the advertisement are tracked. In other words, once the advertisement is actually being displayed, the client computer 125, 130, 135 sends a message to the advertisement server 110 indicating that the advertisement has been displayed to the user. The advertisement server 110 thus keeps track of a number of users or video viewers that have been exposed to the advertisement. Finally, at step 230, click-throughs of the advertisement are also tracked. Typically, an online advertisement may include one or more clickable objects that enable a user to use his computer mouse to point at the clickable object and click on it. This is known as a click-through. The number of click-throughs is typically of interest to the sponsor of the advertisement.

Each, all or any combination of the steps of a computer program as illustrated in FIG. 2 for displaying an advertisement as an overlay upon a video can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents and applications, and publications discussed above are hereby incorporated by reference herein in their entireties.

What is claimed is:

1. A system for displaying one or more advertisements, comprising a server computer and a client computer, the client computer having a monitor, and the client computer being in communication with the server computer via a network,
wherein the server computer is configured to receive a request for a download of a video from the client computer and, in response to the received request, to download the video and the one or more advertisements to the client computer; and
wherein the client computer is configured to receive the downloaded video and the downloaded one or more advertisements from the server computer; and
when a user submits a request for displaying the received video, the client computer is further configured to display the received video on the monitor, and to display the one or more advertisements as an overlay with respect to a portion of the video being displayed.

2. The system of claim 1, wherein the client computer is further configured to begin displaying the one or more advertisements after a predetermined interval from a time at which the display of the received video begins.

3. The system of claim 2, wherein the video includes a start marker corresponding to the predetermined interval, and wherein the client computer is further configured to begin displaying the one or more advertisements in response to an occurrence of the start marker.

4. The system of claim 1, wherein the server computer is further configured to track impressions relating to the display of the one or more advertisements.

5. The system of claim 1, wherein the server computer is further configured to track click-throughs relating to the display of the one or more advertisements.

6. The system of claim 1, wherein at least one of the one or more advertisements is displayed as an overlay with respect to at least 1% of the video being displayed and at most about 75% of the video being displayed.

7. The system of claim 1, wherein at least one of the one or more advertisements is displayed at a location that is selected from the group consisting of a left-hand side of the video, a right-hand side of the video, a bottom side of the video, a top side of the video, and a central location with respect to the video.

8. The system of claim 1, wherein when at least one of the one or more advertisements is displayed, the client computer is configured to enable the user to cause the video to be paused.

9. The system of claim 1, wherein when at least one of the one or more advertisements is displayed, the server computer is configured to automatically pause the video.

10. A system for displaying one or more advertisements, comprising a video server computer, one or more advertisement server computers, and a client computer, the client computer having a monitor, and the video server computer, the one or more advertisement server computers, and the client computer being in mutual communication via a network,
wherein the video server computer is configured to receive a request for a download of a video from the client computer and, in response to the received request, to download the video to the client computer; and
wherein when the video is downloaded to the client computer, the one or more advertisement server computers are configured to download the one or more advertisements to the client computer; and
wherein the client computer is configured to receive the downloaded video from the video server computer and to receive the downloaded one or more advertisements from the one or more advertisement server computers; and
when a user submits a request for displaying the received video, the client computer is further configured to display the received video on the monitor, and to display the one or more advertisements as an overlay with respect to a portion of the video being displayed.

11. The system of claim 10, wherein the client computer is further configured to begin displaying the one or more advertisements after a predetermined interval from a time at which the display of the received video begins.

12. The system of claim 11, wherein the video includes a start marker corresponding to the predetermined interval, and wherein the client computer is further configured to begin displaying the one or more advertisements in response to an occurrence of the start marker.

13. The system of claim 10, wherein the one or more advertisements server computer is further configured to track impressions relating to the display of the one or more advertisements.

14. The system of claim 10, wherein the one or more advertisement server computers are further configured to track click-throughs relating to the display of the one or more advertisements.

15. The system of claim 10, wherein at least one of the one or more advertisements is displayed as an overlay with respect to at least 1% of the video being displayed and at most about 75% of the video being displayed.

16. The system of claim 10, wherein at least one of the one or more advertisements is displayed at a location that is selected from the group consisting of a left-hand side of the video, a right-hand side of the video, a bottom side of the video, a top side of the video, and a central location with respect to the video.

17. The system of claim 10, wherein when at least one of the one or more advertisements is displayed, the client computer is configured to enable the user to cause the video to be paused.

18. The system of claim 10, wherein when at least one of the one or more advertisements is displayed, the video server computer is configured to automatically pause the video.

19. A method for displaying one or more advertisements on a monitor of a client computer, the client computer being in communication with at least one server computer over a network, and the method comprising the steps of:
a) receiving a request for a download of a video from the client computer;
b) in response to the request, causing the video to be displayed on the monitor of the client computer; and
c) causing the one or more advertisements to be displayed on the monitor of the client computer as an overlay with respect to a portion of the video being displayed.

20. The method of claim 19, wherein a beginning of causing the one or more advertisements to be displayed occurs after a predetermined interval from a time at which a beginning of causing the video to be displayed occurs.

21. The method of claim 20, wherein the video includes a start marker corresponding to the predetermined interval, and wherein the beginning of causing the one or more advertisements to be displayed occurs in response to an occurrence of the start marker.

22. The method of claim 19, further comprising the step of tracking impressions relating to the display of the one or more advertisements.

23. The method of claim 19, further comprising the step of tracking click-throughs relating to the display of the one or more advertisements.

24. The method of claim 19, wherein the client computer is in communication with at least a video server computer and an one or more advertisement server computers, and wherein the video server computer is configured to execute steps a) and b), and wherein the one or more advertisement server computers are configured to execute step c).

25. The method of claim 19, wherein at least one of the one or more advertisements is displayed as an overlay with respect to at least 1% of the video being displayed and at most about 75% of the video being displayed.

26. The method of claim 19, wherein at least one of the one or more advertisements is displayed at a location that is selected from the group consisting of a left-hand side of the video, a right-hand side of the video, a bottom side of the video, a top side of the video, and a central location with respect to the video.

27. The method of claim 19, wherein when at least one of the one or more advertisements is displayed, the client computer is configured to enable the user to cause the video to be paused.

28. The method of claim 19, wherein when at least one of the one or more advertisements is displayed, the server computer is configured to automatically pause the video.

29. A computer-readable medium containing a computer program for displaying one or more advertisements, wherein the computer program performs the steps of:
a) receiving a request for a download of a video from a user; and
b) downloading the video and the one or more advertisements,
wherein when the user causes the video to be displayed, the one or more advertisements are displayed as an overlay with respect to a portion of the video being displayed.

30. The computer-readable medium of claim 29, wherein a beginning of displaying the one or more advertisements occurs after a predetermined interval from a time at which the user causes the video to be displayed.

31. The computer-readable medium of claim 30, wherein the video includes a start marker corresponding to the predetermined interval, and wherein the beginning of displaying the one or more advertisements occurs in response to an occurrence of the start marker.

32. The computer-readable medium of claim 29, wherein the computer program further performs the step of tracking impressions relating to the display of the one or more advertisements.

33. The computer-readable medium of claim 29, wherein the computer program further performs the step of tracking click-throughs relating to the display of the one or more advertisements.

34. The computer-readable medium of claim 29, wherein at least one of the one or more advertisements is displayed as an overlay with respect to at least 1% of the video being displayed and at most about 75% of the video being displayed.

35. The computer-readable medium of claim 29, wherein at least one of the one or more advertisements is displayed at a location that is selected from the group consisting of a left-hand side of the video, a right-hand side of the video, a bottom side of the video, a top side of the video, and a central location with respect to the video.

36. The computer-readable medium of claim 29, wherein the computer program further performs the step of enabling the user to pause the video when at least one of the one or more advertisements is being displayed.

37. The computer-readable medium of claim 29, wherein the computer program further performs the step of automatically pausing the video when at least one of the one or more advertisements is displayed.
